(19) United States
(12) Patent Application Publication
(10) Pub. No.: US 2009/0040060 A1
(43) Pub. Date: Feb. 12, 2009

(54) Method for Controlling a Portable Electronic Device Comprising a Power Storage Device

(76) Inventors: Kay Anbuhl, Berlin (DE); Ronald Blum, Berlin (DE)

Correspondence Address: BRINKS HOFER GILSON & LIONE, P.O. BOX 10395, CHICAGO, IL, 60610, US

(21) Appl. No.: 11/886,395

(22) PCT Filed: Mar. 20, 2006
(86) PCT No.: PCT/EP2006/060861

§ 371 Date: Sep. 13, 2007

(30) Foreign Application Priority Data
Mar. 21, 2005 (DE) 10 2005 012 999.4

(51) Int. Cl. G08B 21/00

(52) U.S. Cl. 340/657

(57) ABSTRACT

The invention relates to a method for controlling a portable electronic device comprising a power storage device by means of which the electronic device is supplied or can be supplied either indirectly or directly with power. The inventive method is characterized in that a date/period is stored in the electronic device and that a charge status indication regarding the charge status of the electronic device is output depending on the charge status of the power storage device and on the date/period.

The present patent document is a nationalization of PCT Application Serial Number PCT/EP2006/060861, filed Mar. 20, 2006, designating the United States, which is hereby incorporated by reference. This application also claims the benefit of DE 10 2005 012 999.4, filed Mar. 21, 2005, which is hereby incorporated by reference.

### BACKGROUND

The present embodiments describe a method for controlling a portable electronic appliance with an electrical energy storage device.

Portable electronic appliances are known. For example, a multiplicity of portable electronic appliances exist, such as mobile telephones, organizers, portable computers such as Notebooks or sub-notebooks, audio players such as an MP3 player or the like. The portable electronic appliances, for example, are supplied with electrical power by batteries or rechargeable batteries. The state of charge of the energy storage is difficult for the user to identify. The energy storage, therefore, frequently becomes discharged at a time at which it is impossible, for example, to replace the energy storage or to charge a rechargeable battery. The portable electronic appliances may have a battery status indication. However, the battery status indication may be inaccurate or may be difficult to interpret. Accordingly, it is generally impossible for a normal user to determine the remaining operating time, with an accuracy of a few hours.

### SUMMARY

The present embodiments may obviate one or more of the drawbacks or limitations inherent in the related art. For example, in one embodiment, an improved method for controlling a portable electronic appliance, which allows more reliable operation of the electronic appliance, is provided.

A method for controlling a portable electronic appliance with an electrical energy storage device, which may supply the electronic appliance with electrical power. An appointment time period is stored in the electronic appliance. State of charge information relating to the state of charge of the electronic appliance is emitted as a function of the state of charge of the energy storage device and the appointment time period.

The consideration of an appointment time period in which, for example, it may be impossible to replace or charge the electrical energy storage device makes it possible, for example, to estimate, taking into account an instantaneous state of charge of the electrical energy storage device, when the energy storage device would possibly become discharged, and to provide a user in good time with information to replace or charge it at the appropriate time. Using the described method, an electronic appliance is prevented from becoming unusable as a result of a discharged energy storage at a time at which it is impossible, impracticable and/or inappropriate to replace or charge the energy storage device. For example, this allows more reliable operation of the electronic appliance.

Energy storage devices may be electrical energy storage devices, such as batteries or rechargeable batteries, for storage of electrical energy. However, it is also possible to use an electricity generator, for example, a fuel cell or an internal combustion engine with a generator (for example, a mini-motor) as the energy source for supplying electrical power to the portable electronic appliance. The energy storage device may be a fuel reservoir, for example, for liquid or gaseous fuels, for the electricity generator. Fuel reservoirs may, for example, be a cavity for liquid or gaseous fuels (petrol, methanol, . . . ) or may be a solid tank, for example, for gaseous fuels (for example, a metal hydride reservoir for hydrogen).

The energy storage device may be a direct supply (battery, rechargeable) or an indirect supply of electrical power (fuel for the electricity generator), as described above.

The energy storage device may be a portable energy storage device. The energy storage device and/or the electronic appliance may be designed, for example, such that the energy storage device is carried or can be carried in the appliance or with the appliance.

The state of charge of the energy storage device may, for example, be the charge content of an electrical energy storage or the content of a fuel tank, in each case at a given time. The state of charge may be indicated or displayed, for example, as a percentage of the completely filled storage. For example, the state of charge can be determined by a current or voltage measurement, or a physical filling-level or pressure measurement for a fuel tank. When determining the state of charge, a previous operating period can be taken into account, for example, since the energy storage device was last replaced or was last charged.

Portable electronic appliances may be portable computers of all sizes, for example, Notebooks, sub-notebooks, organizers, palm tops, PDAs (Personal Digital Assistants), or other electronic appliances such as cellular telephones, smart phones, cordless telephones, audio players (such as MP3 players), pocket calculators or the like.

The appointment time period may be in the form of an appointment. An appointment may, for example, comprise a start time and/or an end time. The appointment may also be an individual time (for example, for the issue of documents or the end of a notice period). The appointment time period may be calendar information, such as a holiday, vacation, birthday or the like, or else a task. The stated examples may, for example, each have a start time and/or an end time. For example, the portable electronic appliance to be used may provide a calendar and/or an appointment planner and/or a task planner. The appointment time period may be stored within this calendar and/or appointment planner and/or task planner.

The state of charge information may, for example, include the instantaneous state of charge of the energy storage device, the remaining operating time to be expected and/or information when it will be necessary to replace the energy storage device (for example, information to carry a replacement energy source or that, as a precaution, the energy source should be replaced now). The state of charge information may include information to charge the energy source, in particular now, or to charge it at a stated time.

The state of charge information may be emitted exclusively as a function of the state of charge of the energy storage device and of the appointment time period. The output of the state of charge information may depend not only on the state of charge of the energy storage device and on the appointment time period but also on further parameters. The options mentioned above may be combined as required, for example, one variant or the other may be used depending on the situation.

The state of charge information may be in the form of a text message, an optical message, mechanical signaling and/or an audio message, or may include such messages. An optical message may, for example, be an image message (for example, an image, a graphic, a symbol or a pictogram), or may be in the form of a light signal. An audio message may, for example, be a warning tone, a melody, a file with acoustic data being played back, or text data being transferred to acoustic data (“text-to-speech”).

Mechanical signaling may be provided by a vibration alarm. A vibration alarm is used, for example, in the field of mobile communications (for example, in the case of cellular telephones) in order, for example, to announce the arrival of a call, virtually without any noise. A vibration alarm can be provided, for example, by an oscillating or rotating mass. Mechanical signaling may include individual mechanical pulses or a small number of mechanical pulses which, for example, can be produced by a linear moving or rotating mass.

The output of a text, which informs a user that the energy storage device needs to be replaced or charged, can be combined with a warning tone, which draws the attention of the user to the message. For example, in order to output a text or image, the display device may, for example, be in the form of a liquid crystal display in the electronic appliance. Light elements such as light-emitting diodes or specific display areas on a display unit, a keyboard or key pad, or on a housing of the electronic appliance may be provided in order to emit optical signals.

In one embodiment, the appointment time period includes a start time. The state of charge information is emitted at a time before the start time. There is a higher probability of the user being able to replace or charge the energy source for the portable electronic appliance in sufficient time, before the energy storage becomes discharged at a disadvantageous time. During a stored appointment time period, a user will have planned an activity during which he will frequently have fewer opportunities to replace or exchange the energy storage.

The appointment time period may be associated with location information. The output of the state of charge information may be dependent on the location information. For example, the time at which the state of charge information is emitted depends on the location information. A user may be informed with sufficient time of the need to replace or charge the energy storage when, for example, he has stored an appointment on the basis of which he will be at a different location than his home and/or his place of work. For example, it is possible to provide for the state of charge information to be emitted even one day before the intended appointment, since it can be expected that the user will have to travel to the appointment. If, for example, location information associated with a user's place of work or home is stored for an appointment, then state of charge information can be emitted closer to the appointment time when in the situation described above.

The act of emitting state of charge information may depend on the location information. For example, it is possible to provide for state of charge information to be emitted if the user has an off-site appointment, as described above, while no state of charge is emitted if the user's appointment is at home and/or his place of work.

Alternatively, both of the options mentioned above for emitting state of charge information may be combined as required as a function of location information.

The remaining operating time to be expected of the electronic appliance may be determined, and the state of charge information may be emitted as a function of the remaining operating time to be expected. For example, the remaining operating time can be used to determine whether the electronic appliance is predicted to be ready to operate, or will remain operable, during an appointment time period. For example, state of charge information can be emitted if comparison of the remaining operating time with the appointment time period shows that the energy storage will supposedly become discharged before or during the appointment time period.

The remaining operating time can be determined by determining an average consumption, with the remaining operating time being determined using the average consumption. For example, the average consumption can be determined using consumption data relating to the electrical power from the previous use of the electronic appliance. It is possible to provide an improved method for emitting state of charge information since, for example, the individual usage behavior of a user at that time or the front of the output of the state of charge information is taken into account.

In one embodiment, the appointment time period may comprise an end time, and the state of charge information is then emitted. The state of charge information may be emitted only, when the end of the remaining operating time will occur at a time in the area of the end time or before the end time. The electronic appliance is more reliable, since, for example, state of charge information is emitted when it can be expected that the energy storage device will become discharged before the end of an appointment time period, or will be expected to become discharged approximately at the end time of the appointment time period, such as when the end of the remaining operating time is in the region of the end time. Accordingly, an inaccuracy in the determination of the remaining operating time can be included in the calculation. Inaccuracies in the region of a few minutes, a few tens of minutes or even in the region of one or more hours are always possible.

An appointment time period may include a plurality of individual appointments, or just one individual appointment. When the appointment time period includes a plurality of individual appointments, the start of the first individual appointment in time, for example, can be used as the start time for the appointment time period, and the end of the last appointment of the individual appointment in time can be used as the end time.

Individual appointments may, for example, be adjacent in time, such as by directly following one another or following one another relatively closely (for example within a few tens of minutes or one or more hours). The electronic appliance will be operated reliably even in situations when it is impossible to charge or replace the energy storage device because appointments are closely adjacent to one another in time.

The individual appointments in an appointment time period may be related logically or thematically, for example, it is possible for the individual appointments to be individual appointments during a journey, during which the capabilities to replace or charge the energy source may be restricted.

In one embodiment, the energy storage device is a rechargeable energy storage device. The charging time which is predicted to be required to at least partially recharge the rechargeable energy storage device may be determined from the instantaneous state of charge. For example, the charging time to completely recharge the energy storage device using an external source may be determined from the instantaneous state of charge.

As already described above, the energy storage device may, for example, be an electrical energy storage, such as a rechargeable battery. The external source may, for example, be an external power source and/or a charger. The energy storage device may be a fuel tank (for example, a cavity which can be replenished or else a solid reservoir such as a metal hydrite reservoir for example for hydrogen). The charging time may comprise the actual replenishment time plus an organization time which is required, typically, in order to obtain an appropriate fuel.

The state of charge information may be emitted at a time which precedes the initial time at least by the charging time if a rechargeable energy storage device is used. The user is provided with the state of charge information in sufficiently good time to allow the energy storage device to be at least partially charged. The state of charge information may be emitted at a time which precedes the initial time at least by the charging time, which is required to completely charge the energy storage device.

In one embodiment, a portable electronic appliance includes an electrical energy storage device and a determination device which is designed to determine the state of charge of the electrical energy storage device. The portable electronic appliance also includes a storage device that is designed to store an appointment time period and has a control device. The control device is designed such that state of charge information relating to the state of charge of the electronic appliance may be emitted via an output device as a function of the state of charge and of an appointment time period stored in the storage device.

The portable electronic appliance provides a user of the appliance with a more reliable method for determination of a time to start charging or a time to replace an energy source for portable electronic appliances. Consideration of the stored appointment time period as a function of the state of charge of the energy storage device makes it possible, for example, to use the portable electronic appliance more reliably and for it not to become unusable at times as a result of the energy storage having been discharged.

The energy storage device, its state of charge and the determination of the state of charge, the portable electronic appliance, the state of charge information and the appointment time period may be designed in accordance with the above description.

The control device for the portable electronic appliance can be designed to determine the remaining operating time to be expected of the electrical energy storage device, and emit the state of charge information as a function of the remaining operating time to be expected.

The energy storage device can be a rechargeable energy storage device. The portable electronic appliance may, for example, be designed such that it is designed to determine a charging time for the rechargeable energy storage device, which is may be required for partial or complete charging.

The storage device can store location information which is associated with the appointment time period, and emit the state of charge information as a function of the location information.

The output device may be an acoustic output device, such as a loudspeaker. The output device may be an optical output device, such as at least one light element and/or one screen display device (for example a liquid crystal display). The output device may be in a mechanical output device, for example, to produce a mechanical impulse or vibration. Mechanical output devices may, for example, comprise a mass which can move linearly or rotate. The output device may comprise an acoustic output device, a mechanical output device and/or an optical device according to the above description.

A portable electronic appliance may be designed to carry out the method as described above, or the method variants described above.

### DETAILED DESCRIPTION

The invention will be explained in more detail in an exemplary form in the following text, with reference to a number of examples.

### Example 1

A user has a personal digital assistant (PDA), which is a portable electronic appliance. This PDA comprises an appointment calendar which includes a meeting appointment, lasting for several hours, for the user for the next afternoon. The PDA has a rechargeable battery as a rechargeable energy source.

After determining the state of charge of the rechargeable battery and the remaining operating time determined from the state of charge, together with the predicted energy requirement prior to this appointment and during the appointment, the functionality of the PDA will be ensured throughout the entire meeting, without a charging process. The PDA determines a charging time for the rechargeable battery, with this being the time required to completely recharge the rechargeable battery. At a time advanced by at least the charging time before the start of the meeting appointment, the user will receive a text message with an additional warning tone that he should charge the rechargeable battery in order to ensure continuous use of the PDA.

### Example 2

As in the example above, the electronic appliance is a PDA that has an appointment calendar. In the appointment calendar, a travel appointment is additionally marked as a flight journey, or is automatically identified as such on the basis of appropriate location details relating to the appointment. By statistical analysis of the user behavior, the PDA has determined that the user has the habit (a pattern), for example, of using waiting times at the airport for making telephone calls or for browsing on the Internet. Appointment entries in the PDA are associated with time information and with location information, thus making it possible to statistically record specific habits (patterns) of the user.

In the present example, the predicted energy requirement during a waiting time at the airport, the determined remaining operating time of the PDA, and the predicted charging time required for the rechargeable battery are used to determine that the functionality of the PDA will no longer be ensured before the appointment. A state of charge information may be emitted to the user in sufficient time, suggesting that the PDA should be recharged in sufficient time.

### Example 3

As in the above mentioned examples, the portable electronic appliance is a PDA with an appointment calendar. Each of the meeting appointments in the calendar in the PDA are checked for feasibility with respect to an adequately charged rechargeable battery and, if necessary, a suggestion to charge the rechargeable battery is generated in sufficient time. For example, there is a certain amount of freedom with regard to the point in time at which the suggestion is generated, provided only that the suggestion is produced at the appropriate time. For example, by selecting this degree of freedom, it is possible to coordinate a plurality of charging processes for the power supply, and to coordinate them with the actual energy requirement.

In order to achieve this coordination, time profiles of the energy consumption and the possible charging processes are, for example, estimated. This takes into account the next appointment and all the appointments within a reasonable time period. A suggestion to charge the rechargeable battery is, for example, generated only when a charging capability exists. For example, no suggestion is generated during a meeting, since the technical preconditions for charging the rechargeable battery will probably not be met.

If it is not possible to charge the rechargeable battery sufficiently, this is also signaled to the user and, for example, it is possible to suggest to him that the rechargeable battery at least be charged as much as possible.

The present embodiments relate to a method for controlling a portable electronic appliance with an energy storage device. The energy storage device can supply with electrical power. An appointment time period is stored in the electronic appliance, and state of charge information relating to the state of charge of the electronic appliance is emitted as a function of the state of charge of the energy storage device and the appointment time period. An electronic appliance may carry out the stated method. This method and an appropriately designed portable electronic appliance provide the user of the appliance with an improved capability to avoid usage failures of the appliance. For example, the described method makes it possible to prevent the energy storage for the electronic appliance becoming discharged at times at which replacement or charging of the energy storage is not possible, technically, because of the time, or because of corresponding circumstances.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A method for controlling a portable electronic appliance with an energy storage device that can supply the electronic appliance with electrical power, an appointment time period being stored in the electronic appliance, the method comprising:
emitting a state of charge information of the electronic appliance as a function of a state of charge of the energy storage device and the appointment time.

2. The method as claimed in claim 1, wherein the state of charge information comprises a text message, an image message, mechanical signaling and/or an audio message.

3. The method as claimed in claim 1, wherein the appointment time comprises an initial time, and the state of charge information is emitted at a time before the initial time.

4. The method as claimed in claim 1, wherein the appointment time is associated with location information, and emitting the state of charge information depends on the location information.

5. The method as claimed in claim 14, comprising determining the remaining operating time to be expected of the electronic appliance, and emitting the state of charge information as a function of the remaining operating time to be expected.

6. The method as claimed in claim 5, comprising determining an average consumption, and determining the remaining operating time as a function of the average consumption.

7. The method as claimed in claim 6, comprising determining the average consumption as a function of consumption data from the past.

8. The method as claimed in claim 5, wherein the appointment time comprises an end time, and the method comprising emitting the state of charge information, the state of charge information being emitted only when an end of the remaining operating time occurs at a time essentially in the region of the end time or before the end time.

9. The method as claimed in claim 1, wherein the appointment time comprises a plurality of individual appointments.

10. The method as claimed in claim 1, wherein the energy storage device includes a rechargeable energy storage device.

11. The method as claimed in claim 10, comprising determining an instantaneous state of charge as a function of a charging time which is required in order to at least partially charge the energy storage device again using an external source, and fully charge the energy storage device again.

12. The method as claimed in claim 11, comprising emitting the state of charge information at a time which precedes the initial time at least by the charging time.

13. A portable electronic appliance comprising:
an energy storage device,
a determination device operable to determine the state of charge of the energy storage device,
a storage device operable to store an appointment time, and
a control device operable to emit state of charge information relating to the state of charge of the electronic appliance as a function of the state of charge and of an appointment time which is stored in the storage device via an output device.

14. The portable electronic appliance as claimed in claim 13, wherein the control device is operable to determine a remaining operating time expected of the electronic appliance and to emit the state of charge information as a function of the remaining operating time expected the electronic appliance.

15. The portable electronic appliance as claimed in claim 13, wherein the energy storage device includes a rechargeable energy storage device.

16. The portable electronic appliance as claimed in claim 13, wherein the storage device is operable to store location information associated with the appointment time, and to emit the state of charge information as a function of the location information.

17. The portable electronic appliance as claimed in claim 13, wherein the output device includes an acoustic output device.

18. The portable electronic appliance as claimed in claim 13, wherein the output device includes an optical output device.

19. The portable electronic appliance as claimed in claim 13, wherein the output device is operable to emit mechanical signaling.

20. The portable electronic appliance as claimed in claim 13, wherein the portable electronic appliance is operable to carry out a method as claimed in one of claims 1.

21. The portable electronic appliance as claimed in claim 17, wherein the acoustic output device includes a loudspeaker.

22. The portable electronic appliance as claimed in claim 18, wherein the optical output device includes at least one light element and/or a screen display device.

23. The portable electronic appliance as claimed in claim 10, wherein the output device comprises a mass which can move linearly and/or can rotate.

24. The portable electronic appliance as claimed in claim 13 wherein the appointment time comprises an appointment time period.
